(19) United States
(12) Patent Application Publication
(10) Pub. No.: US 2023/0351212 A1
(43) Pub. Date: Nov. 2, 2023

(54) SEMI-SUPERVISED METHOD AND APPARATUS FOR PUBLIC OPINION TEXT ANALYSIS

(71) Applicant: ZHEJIANG LAB, Hangzhou (CN)

(72) Inventors: Hongsheng WANG, Hangzhou (CN); Qing LIAO, Hangzhou (CN); Hujun BAO, Hangzhou (CN); Guang CHEN, Hangzhou (CN)

(21) Appl. No.: 17/837,233

(22) Filed: Jun. 10, 2022

Related U.S. Application Data
(63) Continuation of application No. PCT/CN2022/093494, filed on May 18, 2022.

(30) Foreign Application Priority Data
Apr. 27, 2022 (CN) 202210447550.2

(51) Int. Cl. G06N 5/02

(52) U.S. Cl. CPC G06N 5/022

(57) ABSTRACT

The disclosure provides a semi-supervised method and apparatus for public opinion text analysis. The semi-supervised method includes: first acquiring a public opinion data set, and preprocessing the data set; performing a data augmentation algorithm on preprocessed samples to generate data augmented samples; generating category labels for the unlabeled samples in the data set in an unsupervised extraction and clustering manner; calculating similarities of word vector latent semantic spaces and performing linear interpolation operation to generate, according to an operation result, similarity interpolation samples; constructing a final training sample set; adopting a semi-supervised method, inputting the final training sample set into a pre-trained language model to train the model to obtain a classification model; and predicting the test set by using the classification model to obtain a classification result.

### CROSS REFERENCE TO RELATED APPLICATION

The present disclosure claims the benefit of priority to Chinese patent application No. 202210447550.2, filed on Apr. 27, 2022 to China National Intellectual Property Administration and titled “Semi-Supervised Method and Apparatus for Public Opinion Text ANALYSIS”, which is incorporated herein by reference in its entirety.

### FIELD

The present disclosure relates to the field of natural language processing, in particular to a semi-supervised method and apparatus for public opinion text analysis.

### BACKGROUND

Existing classification methods in the field of natural language processing include supervised classification, semi-supervised classification, unsupervised classification, and other methods. Among them, the supervised classification method requires a large number of labeled samples, so that the manual labeling cost is high, and thus the supervised classification method is not suitable for some specific scenarios; the unsupervised classification method does not require category information of data and is widely used, but the classification effect is not obvious due to the lack of categories. Semi-supervised learning is a combination of the supervised learning and the unsupervised learning. The combined use of unlabeled samples and a small number of labeled samples can improve the classification accuracy. At the same time, the following problems are solved: the supervised learning method is poor in generalization ability when there are a small number of labeled samples and the unsupervised learning method is inaccurate due to the lack of sample labels. By extending the semantic features of a training sample set and limiting the number of selected extended feature words, an unobvious effect caused by the introduction of excessive noise after the extension is relieved; and the semi-supervised learning method is then used to fully use unlabeled samples to improve the performance of the classification model. An updated training sample set is used to train the classification model and perform prediction, so that a large number of unlabeled samples are fully used to enhance the classification effect.

### SUMMARY

The present disclosure aims to provide a semi-supervised method and apparatus for public opinion text analysis, so as to overcome the shortcomings in the prior art.

In order to achieve the above purposes, the present disclosure provides the following technical solutions:

The present disclosure discloses a semi-supervised method for public opinion text analysis, specifically including the following steps:
S1, acquiring an original public opinion data set, wherein the original public opinion data set includes labeled samples, unlabeled samples and category labels, and the number of the unlabeled samples is less than the number of the labeled samples;
S2, performing text preprocessing on the original public opinion data set, and proportionally dividing the original public opinion data set into a training set and a test set;
S3, performing a data augmentation method on the labeled samples and the unlabeled samples in the training set to respectively obtain augmented samples corresponding to the labeled samples and augmented samples corresponding to the unlabeled samples;
S4, calculating the classification cross-entropy loss of the labeled samples; calculating the relative entropy loss between the unlabeled samples and the augmented samples corresponding to the unlabeled samples; calculating the overall loss of the unlabeled samples and the labeled samples according to the cross-entropy loss and the relative entropy loss;
S5, performing unsupervised extraction and clustering on the unlabeled samples and the augmented samples corresponding to the unlabeled samples to obtain cluster labels;
S6, calculating similarities of the cluster labels; verifying whether the similarities of the cluster labels are greater than a preset category label similarity threshold; if YES, constructing confidence category labels by the cluster labels whose similarities are greater than the preset category label similarity threshold;
S7, calculating the cosine similarities according to word vector latent semantic spaces between the labeled samples and the augmented samples corresponding to the labeled samples, and word vector latent semantic spaces between the unlabeled samples and the augmented samples corresponding to the unlabeled samples to obtain similarity samples; then performing linear interpolation operation on the similarity samples to generate, according to an operation result, similarity interpolation samples;
S8, verifying whether similarities of the similarity interpolation samples are greater than a preset interpolation sample similarity threshold; if YES, constructing confidence samples by the similarity interpolation samples whose similarities are greater than the interpolation sample similarity threshold;
S9, constructing a final training data set by using the category labels of the original public opinion data set, the confidence category labels, the confidence samples, the augmented samples corresponding to the labeled samples, and the augmented samples corresponding to the unlabeled samples;
S10, performing training by using the augmented samples corresponding to the labeled samples and the category label of the original public opinion data set of the final training data set in the step S9 to obtain an initial text classification model; adjusting, according to a classification result, parameters of the initial text classification model; inputting the confidence category labels, the confidence samples and the augmented samples corresponding to the unlabeled samples of the final training data set into the initial text classification model, and performing iterative training to obtain a final text classification model; and
S11, predicting the test set by using the final text classification model in the step S10, and outputting a public opinion text classification result.

As preferably, the step S2 of performing text preprocessing on the original public opinion data set includes the following operations: uniformly standardizing a text length, segmenting texts of the labeled samples and the unlabeled samples into single words by using a word segmentation library, and removing specific useless symbols.

As preferably, in the step S3, the data augmentation method is one or more of a data augmentation back-translation technology, a data augmentation stop-word deletion method or a data augmentation synonym replacement method.

As preferably, the data augmentation back-translation technology includes the following operations: translating samples from its original language into other languages and then translating the samples back into the original language by using a back-translation technology, thus obtaining different sentences with the same semantic meaning, and taking the samples after back-translation as corresponding augmented samples.

As preferably, the data augmentation stop-word deletion method includes the following operations: randomly selecting words that do not belong to a stop-word list from the labeled samples and the unlabeled samples, deleting the words, and taking the samples after the deletion as corresponding augmented samples.

As preferably, the data augmentation synonym replacement method includes the following operations: randomly selecting a certain number of words from the samples, and replacing the words selected from the samples with words in a synonym list, thus obtaining corresponding augmented samples.

As preferably, the step S6 of verifying similarities of the cluster labels specifically includes the following operations: verifying whether a mean value of similarities of the cluster labels of the unlabeled samples and the augmented samples corresponding to the unlabeled samples is greater than a preset category label similarity threshold; if YES, labeling the cluster labels of the unlabeled samples as confidence category labels; and otherwise, labeling the cluster labels of the unlabeled samples as being useless.

As preferably, the step S7 specifically includes the following operations: setting, according to the number of the labeled samples, the number of the augmented samples corresponding to the labeled samples, the number of the unlabeled samples and the number of the augmented samples corresponding to the unlabeled samples, a batch size for similarity calculation and linear interpolation operation, the number of the samples being in an integral multiple relationship with the batch size; calculating cosine similarities of word vector latent semantic spaces between the samples in batches to obtain similarity samples; performing linear interpolation operation on the similarity samples to obtain similarity interpolation samples.

The present disclosure further discloses a semi-supervised apparatus for public opinion text analysis, including an original public opinion sample set acquiring module, configured to acquire an original public opinion data set; a data preprocessing module, configured to perform text preprocessing on the original public opinion data set; a data augmentation module, configured to perform text data augmentation on samples to obtain corresponding data augmented samples; a label extraction and clustering module, configured to extract and cluster category labels of unlabeled samples and augmented samples corresponding to the unlabeled samples to obtain cluster labels of the unlabeled samples; a cluster label similarity verification module, configured to verify similarities of the cluster labels of the unlabeled samples; a confidence category label module, configured to construct confidence category labels by using the cluster labels that have passed similarity verification; a similarity interpolation sample verification module, configured to verify similarities of new samples generated by performing linear interpolation operation on samples obtained by calculating similarities of word vector latent semantic spaces; a confidence sample module, configured to construct confidence samples by using samples that have passed verification of the similarity interpolation samples; a sample set training module, configured to construct a final training sample set; a model training module, configured to train, according to the final training sample set, a classification model to obtain a public opinion text classification model; and a text classification module, configured to input a test set and predict, by using the public opinion text classification model, a text classification result.

The present disclosure further discloses a semi-supervised apparatus for public opinion text analysis, including a memory and one or more processors. The memory stores an executable code; and the one or more processors, when executing the executable code, are applied to the semi-supervised apparatus for public opinion text analysis.

The present disclosure further discloses a computer-readable storage medium, which stores a program. The program, when executed by a processor, implements the semi-supervised apparatus for public opinion text analysis.

The present disclosure has the beneficial effects.

Based on a small number of labeled public opinion samples and unlabeled public opinion samples, an unsupervised extraction and clustering mode is used to extract and cluster the unlabeled public opinion samples to obtain cluster labels, so that the problem of lack of labeled samples is solved, and the accuracy of a text classification model is improved. By verifying whether a label classification result of the final sample is trusted, the influence of untrusted samples on a model can be avoided, and the accuracy of the text classification model can be further improved. When there are a small number of labeled data and no labeled samples, through the semi-supervised learning method, semantic features of training samples can be extended, and an initial classification model constructed by labeled samples is used; augmented samples corresponding to a larger number of unlabeled samples are added into the initial classification model for iterative training until the model converges, thus obtaining a final classification model; and a test set is input into the final classification model for prediction to obtain a classification result. A comparative experiment shows that the method and the apparatus provided in the present disclosure significantly improve the text classification effect when there are a small number of labeled public opinion samples and unlabeled public opinion samples.

The features and advantages of the present disclosure will be described in detail in combination with the embodiments and accompanying drawings.

### BRIEF DESCRIPTION OF THE DRAWINGS

FIG. 1 is an overall flowchart of a semi-supervised method for public opinion text analysis;

FIG. 2 is a flowchart of data preprocessing;

FIG. 3 is a flowchart of data augmentation processing;

FIG. 4 is a flowchart of an overall loss;

FIG. 5 is a flowchart of linear interpolation operation of similarities; and

FIG. 6 is a structural diagram of a semi-supervised apparatus for public opinion text analysis.

### DETAILED DESCRIPTION OF THE EMBODIMENTS

In order to make the objectives, technical solutions and advantages of the present disclosure clearer, the present disclosure will be further described below in detail with reference to accompanying drawings and embodiments. It should be understood that the specific embodiments described here are merely to explain the present disclosure, and not intended to limit the scope of the present disclosure. In addition, in the following descriptions, the descriptions of known structures and known art are omitted to avoid unnecessary confusion of the concept of the present disclosure.

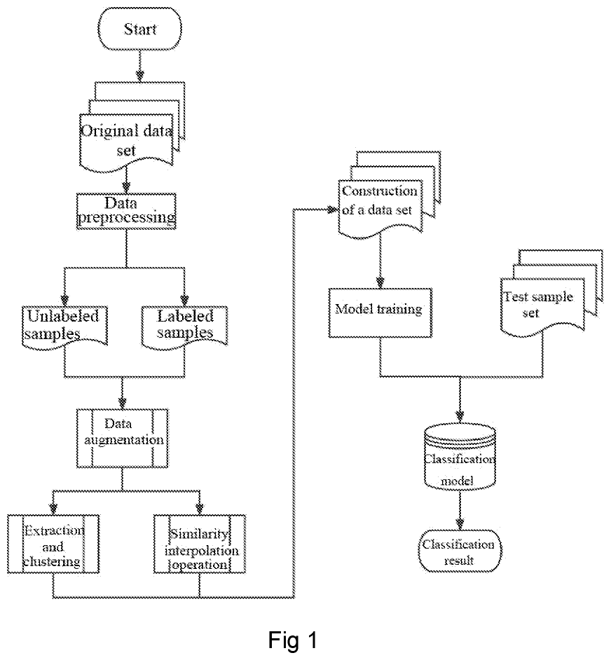

Referring to FIG. 1, according to a semi-supervised method for public opinion text analysis provided by the present disclosure, an original public opinion data set is first acquired; text preprocessing and sample data augmentation are performed to construct a final training sample set; supervised learning training is performed on a smaller number of labeled samples to obtain an initial classifier; parameters are adjusted; augmented samples corresponding to a larger number of unlabeled samples are added into an initial classification model for iterative training until the model converges, thus obtaining a final classification model; and a test set is input into the final classification model for prediction to obtain a classification result.

The present disclosure will be described in detail through the following steps.

The present disclosure relates to a semi-supervised method and apparatus for public opinion text analysis. The entire process is divided into three stages:

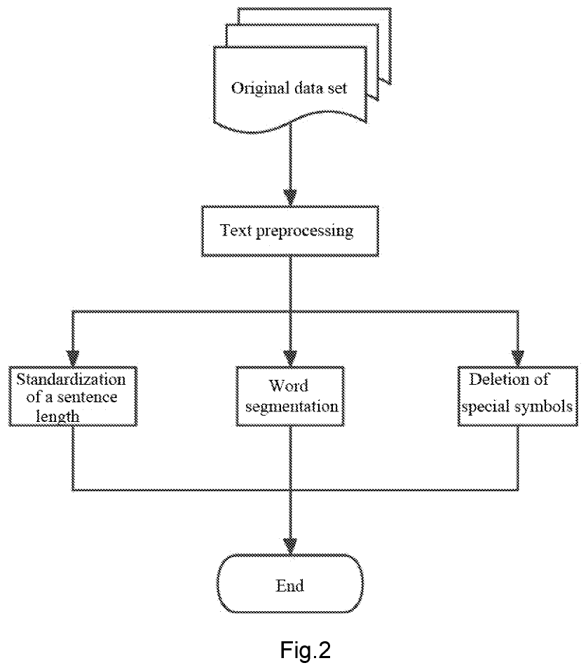

In a first stage of data preprocessing: as shown in FIG. 2, a length of a text sentence is standardized; a word segmentation library (jieba) is used to divide a sample text into single words, and specific useless symbols are removed.

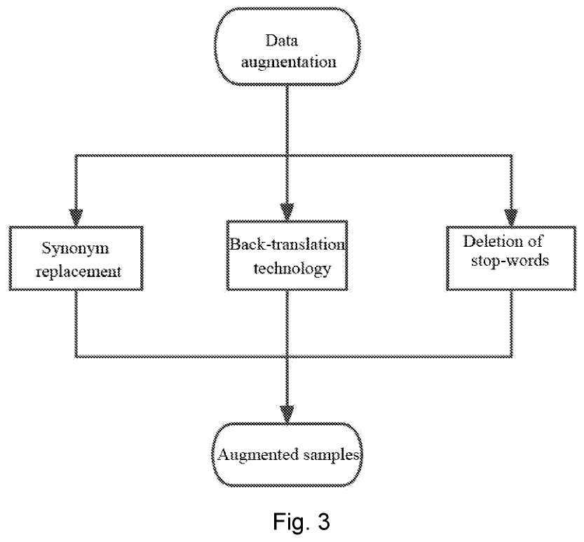

In a second stage of a data augmentation algorithm: as shown in FIG. 3, synonym replacement, back-translation technology and deletion of stop-words are performed; the cross-entropy loss, the relative entropy loss, the overall loss and the cosine similarities are calculated; and by unsupervised extraction and clustering, confidence category labels, linear interpolation operation and confidence interpolation samples, a final training data set is constructed.

In a third stage of training and prediction: a data augmented sample set is input into a pre-training language classification model for training and prediction to obtain a classification result.

Further, the first stage specifically includes: acquiring an initial sample set. The initial sample set includes a small number of labeled public opinion samples, unlabeled public opinion samples and public opinion category labels. The data preprocessing for the labeled samples and the unlabeled samples includes the following substeps:
step I: standardizing a length of a sentence: setting the length of a Chinese sentence to be 150 words;
step II: for a Chinese text classification model, deleting non-Chinese words from the samples, and removing specified useless symbols;
step III: filtering and cleaning stop-words, wherein stop-words refer to “of, and, good, also”, and these words are gathered in a preset stop-word list; when a word in the stop-word list appears in a sample, the above-mentioned word in the sample is deleted; and
step IV: dividing a text in the sample into single Chinese words by using the word segmentation library (jieba).

Further, data augmentation processing is then performed on the preprocessed samples.

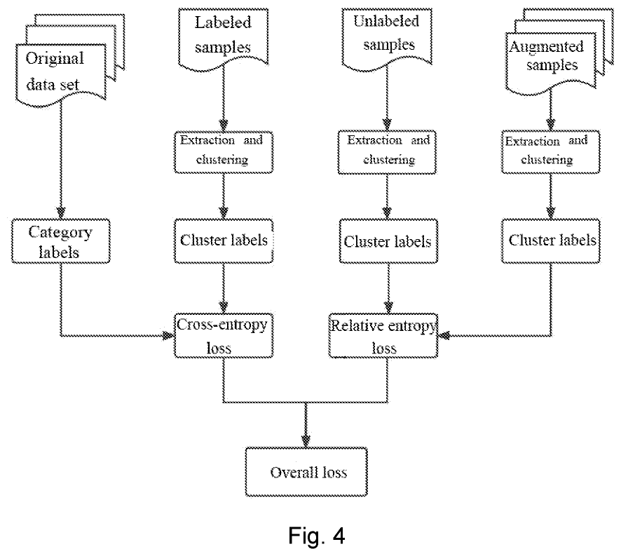

Further, the second stage specifically includes: performing text data augmentation processing on the labeled samples and the unlabeled samples to obtain corresponding data augmented samples. The second stage includes the following substeps:
step I: performing back-translation processing on the labeled samples and the unlabeled samples: first translating the unlabeled samples from Chinese into another language, then retranslating the samples into the initial Chinese language from the another language, thus obtaining different sentences with the same semantic meaning and obtaining corresponding data augmented samples;
step II: acquiring keywords and non-keywords in the samples by using a term frequency-inverse document frequency algorithm; performing word replacement processing on the non-keywords in the labeled samples, thus obtaining corresponding data augmented samples; wherein when the word replacement processing is performed on the non-keywords in the samples, the non-keyword to be replaced in the sample is replaced with another non-keyword;
step III: performing synonym replacement: randomly selecting a certain number of words from the samples, and replacing the words selected from the samples with words in a synonym list, thus obtaining corresponding augmented samples;
step IV: as shown in FIG. 4, calculating the classification cross-entropy loss of the labeled samples; extracting and clustering the labeled samples and the augmented samples corresponding to the labeled samples through an unsupervised extraction and clustering mode by taking category labels as trigger words to obtain cluster labels; mapping the cluster labels to public opinion category labels of the original sample set by using an activation function (Softmax), thus obtaining a category label error between the cluster labels and the original sample set, the error being expressed by a cross-entropy loss function, the formula being as follows:

$$H ( P , Q ) = - {\sum }_{i = 1}^{n} P ( {x}_{i} ) * log Q ( {x}_{i} )$$

wherein H(P, Q) is a cross-entropy loss; P represents a public opinion category label probability distribution of the original sample set; Q represents a cluster label probability distribution; n represents the number of samples; i=1 represents that the number of samples starts from 1;

$${\sum }_{i = 1}^{n}$$

represents summation of the cross-entropy losses of n samples; xᵢ represents a category label; and log is a logarithm;
step V: as shown in FIG. 4, calculating the relative entropy loss of the unlabeled samples; extracting and clustering the category labels of the unlabeled samples through the unsupervised extraction and clustering mode by taking the category labels as trigger words to obtain cluster labels of the unlabeled samples; extracting and clustering augmented sample category labels of the unlabeled samples through the unsupervised extraction and clustering mode to obtain augmented sample cluster labels of the unlabeled samples; and calculating a distance error between the cluster labels of the unlabeled samples and the augmented sample cluster labels of the unlabeled samples, the distance error being expressed by a relative entropy loss function, the formula being as follows:

$${D}_{KL} ( P ‖ Q ) = {\sum }_{i = 1}^{n} [ p ( {x}_{i} ) * log p ( {x}_{i} ) - p ( {x}_{i} ) * log q ( {x}_{i} ) ]$$

wherein D_{KL}(P∥Q) is a relative entropy loss; P is a cluster label probability of the unlabeled samples; Q is an augmented sample cluster label probability of the unlabeled samples; n represents the number of samples; i=1 represents that the number of samples starts from 1;

$${\sum }_{i = 1}^{n}$$

represents the summation of the relative entropy losses of n samples; P is a cluster label probability of each unlabeled sample; log is a logarithm; and q is an augmented sample cluster label probability of each unlabeled sample;
step VI: as shown in 4, calculating the overall loss of the samples: summing the calculated cross-entropy losses and relative entropy losses to which weights are added to obtain the overall loss of the samples, the formula being as follows:

loss=H(P,Q)+λ*D_{KL}(P∥Q)

wherein loss is the overall loss; H(P, Q) is the cross-entropy loss; λ is a weight used for controlling a loss coefficient; D_{KL}(P∥Q) is the relative entropy loss;
step VII: extracting and clustering the labeled samples through the unsupervised extraction and clustering mode by using the category labels of the original public opinion data set as triggers, thus obtaining cluster labels; measuring errors between the cluster labels and the category labels of the original public opinion data set by using the cross entropy; extracting and clustering the unlabeled samples respectively before and after the augmentation through the unsupervised extraction and clustering mode by using the cluster labels as triggers, thus acquiring different results of extraction and clustering for the same piece of data before and after the augmentation; measuring errors between prediction results of the same unlabeled samples before and after the augmentation by using the relative entropy; calculating the overall loss by using the calculated cross entropy loss and relative entropy loss, the overall loss being used for measuring the loss of a label category;
step VIII: calculating cosine similarities between the cluster labels and the category labels of the original public opinion data set; verifying whether the similarities are greater than a preset category label similarity threshold; if YES, constructing confidence category labels by the cluster labels whose similarities are greater than the category label similarity threshold; if NO, deleting the cluster labels; the cosine similarity formula being as follows:

$$cos θ = \frac{{\sum }_{i = 1}^{n} ( {x}_{i} * {y}_{i} )}{\sqrt{{\sum }_{i = 1}^{n} {( {x}_{i} )}^{2}} * \sqrt{{\sum }_{i = 1}^{n} {( {y}_{i} )}^{2}}}$$

wherein cosθ is the cosine similarity; n represents the number of samples; i=1 represents that the number of category labels starts from 1;

$${\sum }_{i = 1}^{n}$$

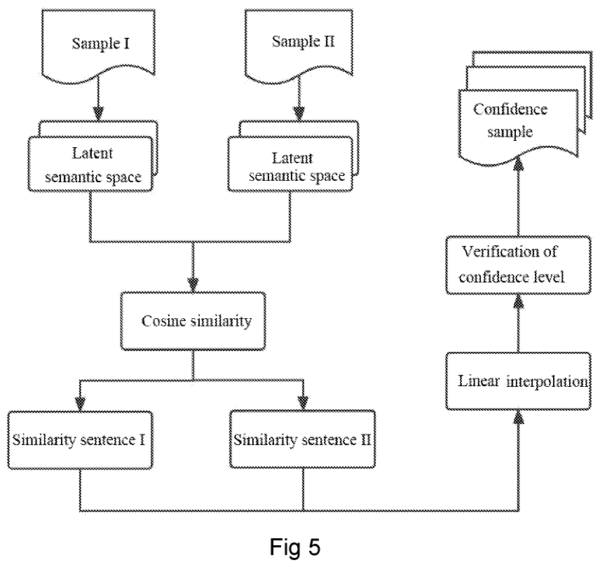

represents summation; xᵢ represents a cluster label; and yᵢ represents the category labels of the original public opinion data set;
step IX: as shown in FIG. 5, setting, according to the number of the unlabeled samples, the number of the augmented samples corresponding to the unlabeled samples, the number of the labeled samples and the number of the augmented samples corresponding to the labeled samples, a batch size for similarity calculation and linear interpolation operation by means of word vector latent semantic spaces between samples, the number of the samples being in an integral multiple relationship with the batch size; iteratively randomly acquiring two sentences in batches, setting the two sample sentences to have the same length, calculating a cosine similarity of the word vector latent semantic spaces between the two sentences to obtain two similarity sentences, performing linear interpolation operation on the similarity sentences to obtain two similarity interpolation sentences, and combining feature spaces of the two similarity interpolation sentences to obtain a similarity interpolation sample, wherein the linear interpolation operation formula is as follows:

λ=max(λ,1−λ);

X=λ*Xᵢ+(1−λ)*Xⱼ;

Y=λ*Yᵢ+(1−λ)*Yⱼ;

where λ represents the weight for controlling a linear interpolation operation coefficient, and λ is between 0 and 1; max represents a maximum value; X represents similarity interpolation sentence I; Xᵢ and Xⱼ represent the similarity sentences; Y represents similarity interpolation sentence II; Yᵢ and Yⱼ represent the similarity sentences;
step X: calculating confidence levels of the similarity interpolation samples; verifying whether the confidence levels are greater than a preset interpolation sample confidence level threshold; if YES, constructing confidence samples by the similarity interpolation samples whose confidence levels are greater than the interpolation sample confidence level threshold; if NO, deleting the similarity interpolation samples; and
step XI: constructing a final training data set by using the category labels of the original public opinion data set, the confidence category labels, the confidence samples, the augmented samples corresponding to the labeled samples, and the augmented samples corresponding to the unlabeled samples.

Further, the third stage specifically includes: performing model training and predicting category labels of a public opinion text, including the following substeps:
step I: performing model training: inputting the augmented samples corresponding to the labeled samples and the category labels of the original public opinion data set of the final training data set into a BERT Chinese pre-training model for training to obtain an initial text classification model, thus predicting label category distribution thereof; adjusting parameters of the initial text classification model according to a classification result; adding regularization in order to prevent overfitting of the model; and inputting the confidence category labels, the confidence samples and the augmented samples corresponding to the unlabeled samples of the final training data set into the initial text classification model for iterative training;
step II: predicting a result: performing iterative training to obtain a public opinion text analysis classification model, and inputting a public opinion test set into the public opinion text analysis classification model to predict a public opinion text analysis classification result.

### Embodiment

Step I: acquiring a public opinion text data set including 30000 public opinions: 5000 labeled samples, 22000 unlabeled samples, and 3000 test samples.
Step II: in Experiment I, by the semi-supervised method for public opinion text analysis provided by the present disclosure, using the public opinion text data set of the step I to predict, according to the steps of the specific implementation of the present invention, 3000 test samples, the classification accuracy being 87.83%.
Step III: in Experiment II, by the opinion text data set of the step I, using the BERT pre-training model to predict 3000 test samples, the classification accuracy being 84.62%.

If the same data set is used, comparison of two groups of experimental results is as shown in the following table:

| | Training | Test | Classification | Classification |
|---|---|---|---|---|
| | sample | sample | method | accuracy |
| Experiment | 27000 | 3000 | The | 87.83% |
| I | | | semi-supervised | |
| | | | method of the | |
| | | | present | |
| | | | disclosure | |
| Experiment | 27000 | 3000 | BERT | 84.62% |
| II | | | pre-training | |
| | | | model | |

Furthermore, according to the experiments, when the label data of each category is extremely limited, the improvement of model accuracy is particularly obvious. Through the comparison with experiments of other text classification data sets, the semi-supervised method and apparatus for text analysis provided in the present disclosure can significantly improve the public opinion text analysis classification accuracy.

The present disclosure further discloses a semi-supervised apparatus for public opinion text analysis, including an original public opinion sample set acquiring module, configured to acquire an original public opinion data set; a data preprocessing module, configured to perform text preprocessing on the original public opinion data set; a data augmentation module, configured to perform text data augmentation on samples to obtain corresponding data augmented samples; a label extraction and clustering module, configured to extract and cluster category labels of unlabeled samples and augmented samples corresponding to the unlabeled samples to obtain cluster labels of the unlabeled samples; a cluster label similarity verification module, configured to verify similarities of the cluster labels of the unlabeled samples; a confidence category label module, configured to construct confidence category labels by using the cluster labels that have passed similarity verification; a similarity interpolation sample verification module, configured to verify similarities of new samples generated by performing linear interpolation operation on samples obtained by calculating similarities of word vector latent semantic spaces; a confidence sample module, configured to construct confidence samples by using samples that have passed verification of the similarity interpolation samples; a sample set training module, configured to construct a final training sample set; a model training module, configured to train, according to the final training sample set, an initial text classification model to obtain a public opinion text classification model; and a text classification module, configured to input a test set and predict, by using the public opinion text classification model, a text classification result.

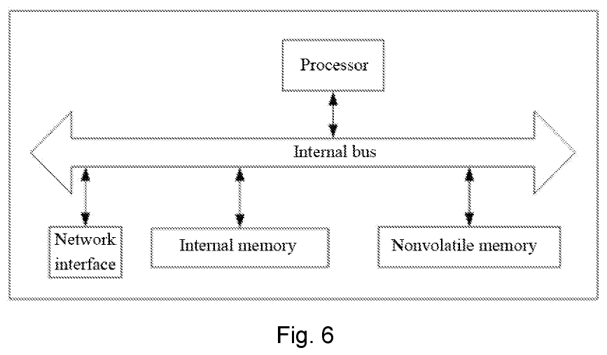

The embodiment of the semi-supervised apparatus for public opinion text analysis of the present disclosure can be applied to any device with data processing capability. Any device with data processing capability may be a device or apparatus such as a computer. The apparatus embodiment may be implemented by software, or may be implemented by hardware or a combination of software and hardware. Implementation by software is taken as an example, an apparatus in a logical sense is formed by reading corresponding computer program instructions in a nonvolatile memory into an internal memory through a processor of any device with the data processing capability where it is located. In terms of hardware, as shown in FIG. 6, a hardware structure diagram of any device with the data processing capability where the semi-supervised apparatus for public opinion text analysis of the present disclosure is located is illustrated. In addition to the processor, an internal memory, a network interface and a non-volatile memory shown in FIG. 6, any device with the data processing capability where the apparatus in the embodiment is located may also include other hardware usually according to the actual functions of any device with the data processing capability, and repeated descriptions are omitted here. For details of the implementation process of the functions and effects of all units in the above apparatus, the implementation processes of the corresponding steps in the above method are referred to, and repeated descriptions are omitted here.

For the apparatus embodiment, since it basically corresponds to the method embodiment, reference may be made to the partial description of the method embodiment for related parts. The device embodiments described above are only illustrative, and the units described as separate components may or may not be physically separated, and the components displayed as units may or may not be physical units, that is, they may be located in one place, or may be distributed over multiple network units. Some or all of the modules may be selected according to actual needs to achieve the objectives of the solutions of the present disclosure. Those of ordinary skill in the art can understand and implement it without creative effort.

An embodiment of the present disclosure further provides a computer-readable storage medium, which stores a program, wherein the program, when executed by a processor, implements the semi-supervised method for public opinion text analysis in the above embodiment.

The computer-readable storage medium may be an internal storage unit of any device with the data processing capability described in any one of the foregoing embodiments, such as a hard disk or an internal memory. The computer-readable storage medium may also be an external storage device of any device with the data processing capability, such as a plug-in hard disk, a smart media card (SMC), an SD card, and a flash card. Further, the computer-readable storage medium may also include both an internal storage unit and an external storage device of any device with the data processing capability. The computer-readable storage medium is used for storing the computer program and other programs and data required by any device with the data processing capability, and can also be used for temporarily storing data that has been output or will be output.

The above descriptions are only the preferred embodiments of the present disclosure, and are not intended to limit the present disclosure. Any modifications, equivalent replacements or improvements, and the like that are made within the spirit and principle of the present disclosure shall fall within the protection scope of the present disclosure.

1. A computer-implemented method comprising following steps:
S1, acquiring an original public opinion data set, wherein the original public opinion data set comprises labeled samples, unlabeled samples and category labels, and the number of the unlabeled samples is less than the number of the labeled samples;
S2, performing text preprocessing on the original public opinion data set, and dividing the original public opinion data set into a training set and a test set proportionally;
S3, performing a data augmentation method on the labeled samples and the unlabeled samples in the training set to respectively obtain augmented samples corresponding to the labeled samples and augmented samples corresponding to the unlabeled samples;
S4, calculating a classification cross-entropy loss of the labeled samples; calculating a relative entropy loss between the unlabeled samples and the augmented samples corresponding to the unlabeled samples; calculating an overall loss of the unlabeled samples and the labeled samples according to the classification cross-entropy loss and the relative entropy loss;
S5, performing unsupervised extraction and clustering on the unlabeled samples and the augmented samples corresponding to the unlabeled samples to obtain cluster labels;
S6, upon determination that the similarities of the cluster labels are greater than a preset category label similarity threshold, constructing confidence category labels by the cluster labels whose similarities are greater than the preset category label similarity threshold;
S7, calculating cosine similarities according to word vector latent semantic spaces between the labeled samples and the augmented samples corresponding to the labeled samples, and word vector latent semantic spaces between the unlabeled samples and the augmented samples corresponding to the unlabeled samples to obtain similarity samples; then performing linear interpolation operation on the similarity samples to generate, according to an operation result, similarity interpolation samples;
S8, upon determination that similarities of the similarity interpolation samples are greater than a preset interpolation sample similarity threshold, constructing confidence samples by the similarity interpolation samples whose similarities are greater than the interpolation sample similarity threshold;
S9, constructing a final training data set by using the category labels of the original public opinion data set, the confidence category labels, the confidence samples, the augmented samples corresponding to the labeled samples, and the augmented samples corresponding to the unlabeled samples;
S10, performing training by using the augmented samples corresponding to the labeled samples and the category labels of the original public opinion data set of the final training data set to obtain an initial text classification model; adjusting, according to a classification result, parameters of the initial text classification model; inputting the confidence category labels, the confidence samples and the augmented samples corresponding to the unlabeled samples of the final training data set into the initial text classification model, and performing iterative training to obtain a final text classification model; and
S11, predicting the test set by using the final text classification model, and outputting a public opinion text classification result.

2. The computer-implemented method according to claim 1, wherein performing the text preprocessing on the original public opinion data set comprises the following operations: uniformly standardizing a text length, segmenting texts of the labeled samples and the unlabeled samples into single words by using a word segmentation library, and removing specific useless symbols.

3. The computer-implemented method according to claim 1, wherein the data augmentation method is a data augmentation back-translation technology, a data augmentation stop-word deletion method or a data augmentation synonym replacement method.

4. The computer-implemented method according to claim 3, wherein the data augmentation back-translation technology comprises the following operations: translating samples from its original language into other languages other than the original language, and then translating the samples back into the original language by using a back-translation technology, thus obtaining different sentences with the same semantic meaning, and taking the samples after back-translation as corresponding augmented samples.

5. The computer-implemented method according to claim 3, wherein the data augmentation stop-word deletion method comprises the following operations: randomly selecting words that do not belong to a stop-word list from the labeled samples and the unlabeled samples, deleting the words, and taking the samples after the deletion as corresponding augmented samples.

6. The computer-implemented method according to claim 3, wherein the data augmentation synonym replacement method comprises the following operations: randomly selecting several words from the samples, and replacing the words selected from the samples with words in a synonym list, thus obtaining corresponding augmented samples.

7. The computer-implemented method according to claim 1, wherein upon determination that a mean value of similarities of the cluster labels of the unlabeled samples and the augmented samples corresponding to the unlabeled samples is greater than the preset category label similarity threshold, labeling the cluster labels of the unlabeled samples as confidence category labels; and otherwise, labeling the cluster labels of the unlabeled samples as being useless.

8. The computer-implemented method according to claim 1, wherein step S7 comprises the following operations: setting, according to the number of the labeled samples, the number of the augmented samples corresponding to the labeled samples, the number of the unlabeled samples and the number of the augmented samples corresponding to the unlabeled samples, a batch size for similarity calculation and linear interpolation operation, the number of the samples being in an integral multiple relationship with the batch size; calculating cosine similarities of word vector latent semantic spaces between the samples in batches to obtain similarity samples; performing linear interpolation operation on the similarity samples to obtain similarity interpolation samples.

9. (canceled)

10. An apparatus, comprising a non-transitory memory and one or more processors, wherein the non-transitory memory stores an executable code; the one or more processors, when executing the executable code, is configured to implement the method according to claim 1.

11. A non-transitory computer-readable storage medium, which stores a program, wherein the program, when executed by a processor, implements the method according to claim 1.
